(19) United States
(12) Patent Application Publication
(10) Pub. No.: US 2011/0139081 A1
(43) Pub. Date: Jun. 16, 2011

(54) Cat litter cleaner

(76) Inventor: Bart E. Greenhut, South Pasadena, CA (US)

(21) Appl. No.: 12/653,374

(22) Filed: Dec. 14, 2009

(51) Int. Cl. A01K 29/00

(52) U.S. Cl. 119/167

(57) ABSTRACT

Apparatus for cleaning a cat litter box to remove lumps of excrement while leaving most of the particles of liter in the box, and for hygienically disposing of the removed lumps. The apparatus includes a flexible bag (32) with a front bag end (36) forming a main opening (34) and with a rear bag portion (72) having multiple small openings (70). A wire frame ((40) holds the bag main opening in an open state, and a cardboard handle (42) holds the wire frame and bag front end. The handle is used to drag the bag forwardly through the pool of particles in the litter box while lumps larger than the small openings are captured in the bag. The handle is then slid down to close the bag, and the bag with lumps therein is disposed of as by dropping it in a garbage can.

### BACKGROUND OF THE INVENTION

Homes that have an indoor household cat as a pet, usually have a litter box in which the cat excretes urine and feces. Litter in the litter box should be cleaned at intervals such as every day and the litter should be changed at less frequent intervals. Otherwise odor builds up and a fastidious cat may find other locations in a house for urination or defecation. By cleaning the litter box, a person removes much of the lumps of excrement so the litter has to be changed less frequently to save on the cost of fresh litter and the work in emptying and cleaning the box.

The pool of litter particles in a litter box can be cleaned by the use of a scoop that is pushed or dragged through the pool of litter to pick up lumps of excrement. The scoop has openings that let litter particles pass through, with the openings small enough to trap lumps of excrement. The lumps are formed by lumps of feces and by the clumping together of litter particles when urine has been deposited on them. When lumps lie on the scoop, the lumps are disposed of by turning the scooper upside-down to allow the lumps to drop into a bag that is carried to a garbage can, or by holding the scooper while walking to a toilet or garbage can and dumping the lumps into the toilet or can. When disposed of in a garbage can, the clumps may attract flies. Many people find it disagreeable to handle the scooper with exposed cat feces especially if the feces is soft, or to allow the clumps to remain in a garbage can that may attract flies. Furthermore, the scooper may have to be washed if soft feces sticks to it, or left unwashed in a house. If the lumps are to be dropped into a bag, there may be difficulty in holding the bag open while dumping the lumps. A low cost apparatus that could be operated in a simple manner to scoop lumps of excrement from a litter box and quietly dispose of them and which then largely covered the lumps, and which avoided keeping a contaminated scooper in the home, would be of value.

### SUMMARY OF THE INVENTION

In accordance with one embodiment of the invention, a low cost and easily manipulated apparatus is provided that facilitates the cleaning of litter in a litter box. The apparatus includes a flexible bag with a main opening at its front end, a wire frame that holds the bag main opening open during the scooping of lumps of excrement from the pool of liter in the litter box, and a handle that supports the wire frame and bag front end and that can be slid down on the frame to close the bag main opening. The bag has smaller holes rearward of the main opening, so when the handle is moved forward to scoop litter through the bag main opening, particles of litter can pass rearward through the smaller holes but lumps of excrement cannot pass through the smaller holes and the lumps remain in the bag.

After a person believes that there has been sufficient scooping of the litter box, the person presses down the handle. The handle is pushed down to slide along the wire frame and close the main opening of the bag. The apparatus with a closed main opening is carried to a waste disposal site such as a garbage can and dropped in. The fact that the bag main opening is closed helps avoid free access of flies to the lumps of excrement. Since the entire apparatus is disposed of, there are no parts to be cleaned or that will remain uncleaned in the home.

The novel features of the invention are set forth with particularity in the appended claims. The invention will be best understood from the following description when read in conjunction with the accompanying drawings.

### DESCRIPTION OF THE DRAWINGS

FIG. 1 is an isometric view of a cat litter box with lumps of excrement in the pool of litter and with the cover shown only in phantom lines.

FIG. 2 is a front isometric view of an apparatus of the invention for cleaning the pool of litter in the litter box of FIG. 1, with the apparatus shown with its bag main opening in an open state.

FIG. 3 is a rear isometric view of the apparatus of FIG. 2, with the bag main opening in a closed state.

FIG. 4 is an enlarged view showing how particles can pass through small openings of the bag of FIG. 2, while lumps are trapped in the bag.

### DESCRIPTION OF THE PREFERRED EMBODIMENTS

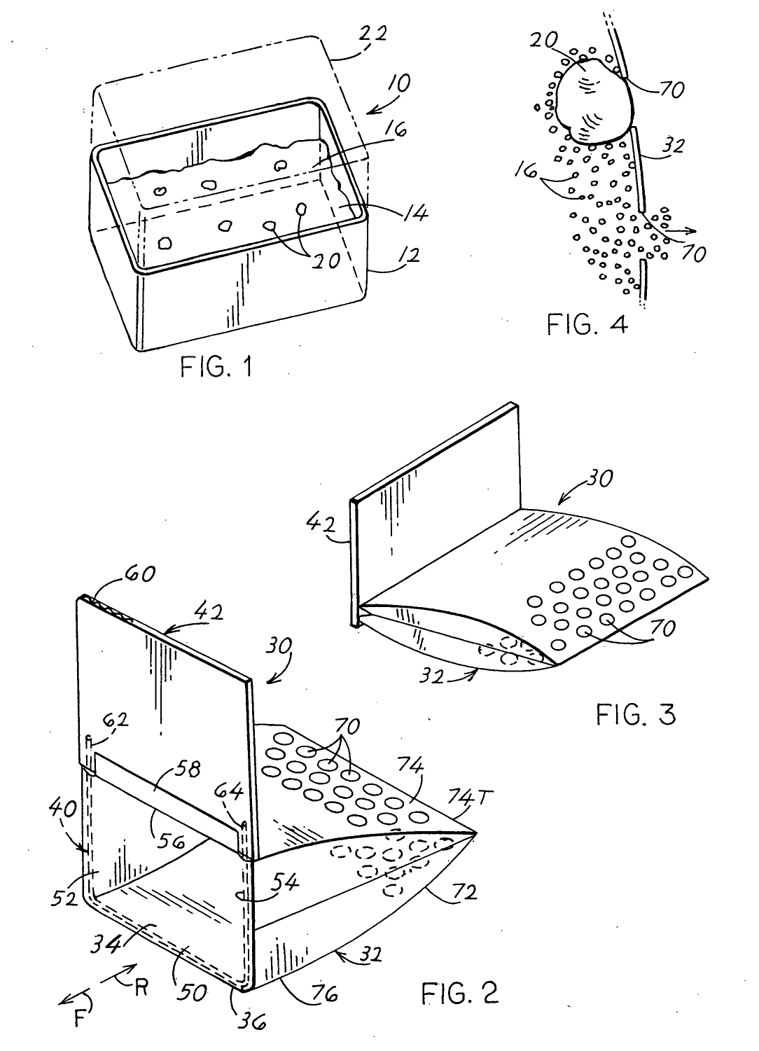

FIG. 1 shows a cat litter box 10 which includes a base 12 that holds a pool 14 of litter particles, or litter 16. The pool 14 shown has been used by a cat, and contains lumps 20 of excrement. Some of the lumps comprise lumps of feces, while other lumps may (or may not) comprise clumps of particles held together by the effects of urine. The litter 16 can be any of a variety of materials, but is usually particles having a width and length of less than one-eighth inch long and wide and usually less than one-sixteenth inch. Bentonit, or clumping litter, is often used, which absorbs urine into clumps. A cover 22 covers the base when the box is used by a cat, but the cover is removed to clean the litter box.

The litter box can be partially cleaned easily and at low cost by scooping out the lumps 20 so the remaining litter can be reused. This may be done every day or two. The litter box can be more thoroughly cleaned perhaps every three days, by emptying the box of all litter, cleaning the box, and pouring in fresh letter. The lumps 20 can be removed by moving a scooper, which is a hand-held one-piece plastic tool with slots or holes of about three-eighths inch width, through the pool of litter. Lumps are retained on the scooper but particles are not retained. As discussed above, this has the disadvantage that a person must keep a bag open while dumping feces into the bag or carry the scooper with fully exposed feces to a disposal site. In either case, when the feces is dumped into a garbage can flies often find their way to the fully exposed feces in the can. Also, the soft feces may stick to the scooper and a person may decide that it is necessary to clean the scooper. The unwashed scooper generally retains some feces, which attracts flies and other insects.

FIG. 2 shows a scooper apparatus 30 of the present invention, which includes a flexible bag 32 with a main opening 34 at its front end 36, a wire frame 40 that mounts to walls of the main opening, and a handle 42. The bag has a lower main opening lower wall 50 and a pair of main opening side walls 52, 54 that are mounted or positioned on the wire frame 40. The bag also has a main opening upper wall 56 forming a flap 58 that is fixed to the handle 42. The handle is formed of corrugated cardboard that has vertical passages 60, and the wire frame has upward extending arms 62, 64 that can slide in the cardboard passages. When the cardboard handle is pushed down, the wire frame arms 62, 64 slide into the handle, and the bag upper wall is moved down to lie adjacent to the lower wall, as in FIG. 3, so the bag is largely closed. This bag is similar to the Disposable Waste Scooper invented by applicant and described in U.S. Pat. No. 4,718,707.

In accordance with the invention, applicant provides smaller, or small holes 70 in the flexible bag 32 along a bag portion that is rearward of the bag main opening 34. The smaller holes 70 each is much smaller than the main opening 34, and at least some, and preferably a majority, of the small holes lie in a rearward portion 72 of the main bag that lies closer to the bag rear end 74 (it is rearward during scooping) than to the bag front end 36. However, preferably there are no hole at the extreme rearward tip 74t. The small holes 70 prevent large lumps of excrement from passing through so such large lumps become trapped in the bag. Small lumps and unclumped litter particles readily pass through the small holes. Although small holes also may be provided in the front portion of the bag (closer to the front end 36 than the rear end), such forward small holes are not as effective in allowing particles to pass while clumps are trapped, as are the rearward holes.

A person cleans litter in the litter box by removing the box cover 22, and lowering the lower part 76 of the bag into the pool of litter so the bag is at least partially submersed. The person repeatedly drags the bag forwardly F through the litter, and lifts the bag above the pool of litter and moves the bag back to the box rear portion and down into it, after each forward dragging. The bag is moved forwardly by a person holding the handle 42 and moving it to move the frame and handle forwardly. Litter freely enters the bag main opening 34 and presses litter already in the bag to move rearward R. Most of such litter exits the bag through the small holes 70. Lumps 20 of sufficient size cannot exit through the smaller holes so such lumps remain in the bag.

After the bag has been repeatedly dragged through the litter, a considerable portion of the larger lumps lie in the bag. A person then may remove the scooper apparatus 30 from the base 12 and press the handle 42 firmly downward until the bag is closed (that is, the main opening area is preferably no more than one-tenth its original area), as shown in FIG. 3. The frame 40 is stationary in that the handle moves down relative to the frame and bag. The person may close the bag while the apparatus remains in the base. The person then may shake the apparatus while it lies over the base to allow particles to fall out. The person then may walk with the closed bag to a garbage can or other disposal site and throw the bag in. The bag rearward of the front end is not entirely closed because the small holes 70 remain open. However, the small holes are largely blocked by lumps, and insects such as flies do not enter small holes as readily as large openings or completely uncovered devices such as prior art scoopers that loosely support but that do not enclose lumps of excrement. The cardboard handle preferably contains instructions for using the apparatus, which is easily used especially after the operation is first viewed in a commercial or demonstration.

In a scooper apparatus that applicant has constructed and successfully tested, the bag had a bag main opening 34 of a horizontal width of 4 inches and a vertical height of 2½ inches, the bag had a front-to-rear length of 6 inches and the handle had a height of 3½ inches. The small holes (36 of them) each was round and each had a diameter of ¼th inch. The bag main opening should have an opening area of a plurality of square inches, while the small holes should each have an opening area that is less than one tenth that of the main opening. The bag, the cardboard handle, and the wire frame each costs pennies, so the scooper apparatus can be constructed and sold at a low cost.

Domestic cats typically weigh between four and five kilograms (nine and eleven pounds). The small holes, or small openings (which could be slots in a stronger bag) have a width of no more than one-half inch, and preferably have a diameter between one-eighth and three-eighths inch (area of 0.012 square inch and 0.11 square inch). This enables the removal of most of the volume of lumps in a litter box from such typical cats in a short period of time such as during about six scoops of the scooper apparatus.

Thus, the invention provides a low cost and easily used scooper apparatus that is useful to clean litter in a litter box, and especially a cat litter box for a domestic house cat. The apparatus includes a flexible bag with a main opening at its front end and with small holes in its rear portion, a frame that is preferably a wire frame, and a handle which is preferably a corrugated cardboard handle. The scooper apparatus is used by repeatedly moving the handle forwardly above a pool of litter in a litter box while the bag main opening lies in the pool of litter, so particles and lumps enter the bag main opening and tend to move towards the rear of the bag. The larger lumps are retained while small lumps and unclumped particles pass out through the smaller holes. After the person moving the bag believes the bag is sufficiently filled with lumps (i.e. that the litter has been cleaned sufficiently), the person closes the bag main opening by pressing down the cardboard handle, and carries the bag and disposes of it in a garbage can or other disposal site. It would be possible to use a stiffer bag with slots of about one-quarter inch width to scoop the litter pool, instead of holes, but such slots are the equivalent of applicant's small holes. After the litter box has been cleaned, there is no scooper (usually contaminated with a small amount of feces) to be stored.

Although particular embodiments of the invention have been described and illustrated herein, it is recognized that modifications and variations may readily occur to those skilled in the art, and consequently, it is intended that the claims be interpreted to cover such modifications and equivalents.

1. Apparatus for cleaning a cat litter box that contains numerous particles of cat litter that hold excrement that includes urine and feces of a cat, by removing lumps of excrement, comprising:
a flexible bag having bag front and rear ends and having bag front and rear end portions, said bag front portion forming bag main opening walls and forming a main opening within said main opening walls, said main opening having an area of more than one square inch, and said bag rear portion is closed except for small holes;
a frame, said bag main opening walls being mounted on said frame with said frame constructed to hold said bag main opening in an open state;
a handle that is mounted on said frame with said handle being movable to move said main opening forwardly through litter in said litter box so litter enters the main opening;
said flexible bag having a plurality of said small holes lying rearward of said main opening and closer to said bag rear end than to said bag front end, said small holes each having an area of less than one-tenth the opening area of said main opening so unclumped litter particles can pass through said small holes, but larger lumps of animal excrement do not pass through said small holes and remain in the bag.

2. The apparatus described in claim 1, wherein:
a majority of said small holes lies closer to said rear bag end than to said front bag end;
said bag main opening walls include top, bottom and opposite side bag walls;
said frame includes a stationary frame portion that is attached to said bottom and opposite side walls of said opening walls, with said top bag wall fixed to said handle;
said handle is moveable to lower said top bag wall and close said main opening, so the bag with lumps of excrement therein can be more easily disposed of.

3. The apparatus described in claim 1 wherein:
said small holes each has an area of no more than 0.11 square inch, whereby to capture excrement lumps created by household cats.

4. The apparatus described in claim 1 wherein said apparatus is useful for cleaning the litter box of a domestic cat, and wherein:
said small holes each has a hole width of one-eighth to three-eighth inch.

5. Apparatus for cleaning a domestic cat litter box that contains particles of litter and lumps of excrement, comprising:
a bag having a open front end, a rear end, and a bag rear portion that extends from a location halfway between said front and rear ends to said rear end;
means that can be held by a person for keeping said bag front end open so the open front end can be dragged primarily horizontally through litter in the litter box to capture lumps, and for closing said bag front end without the person contacting the lumps of excrement;
said bag rear portion having a plurality of small holes that each has a width of no more than one-half inch to let said litter particles escape through the small holes while blocking the escape of larger lumps, said bag open front end having more than ten times the area of each of said small holes.

6. The apparatus described in claim 5 wherein:
said small holes each has a width and length of one-eighth to three-eighth inch.

7. The apparatus described in claim 5 wherein:
a majority of small holes in said bag, lies closer to said rear bag end than to said front bag end.

8. A method for cleaning a pool of cat litter particles in a litter box that also contains lumps of excrement, comprising:
holding an apparatus that includes a handle, a wire frame, and a flexible bag, including holding said handle while it supports said wire frame and while said wire frame holds open a bag main opening that lies at a front end of said flexible bag, wherein said bag has small holes rearward of said main opening wherein said small holes each has an area less than one-tenth the area of said main opening;
while holding said handle, repeatedly moving the bag main opening primarily horizontally, forward through said pool of cat litter while allowing said litter particles to pass through said main opening and through said small openings back into the pool of cat litter and while allowing a plurality of said lumps to pass through said main opening but not through said smaller openings, to thereby accumulate lumps and a minimum of litter particles in the bag;
removing said apparatus completely from said litter box;
closing said bag to close said main opening, and disposing of said apparatus with said lumps in said bag.
